(19) United States
(12) Patent Application Publication
(10) Pub. No.: US 2012/0076956 A1
(43) Pub. Date: Mar. 29, 2012

(54) Polarizing plate, liquid crystal display device using the same and moisture- and heat-resistant protective film for polarizing plate

(75) Inventor: Hidenori Hayashi, Kanagawa (JP)

(73) Assignee: FUJIFILM Corporation, Tokyo (JP)

(21) Appl. No.: 13/200,393

(22) Filed: Sep. 23, 2011

(30) Foreign Application Priority Data
Sep. 29, 2010 (JP) 2010-218302

(51) Int. Cl. C09K 19/00; B32B 7/02; B32B 3/00

(52) U.S. Cl. 428/1.33; 428/336; 428/216

(57) ABSTRACT

A polarizing plate comprising a polarizing film, and on one surface thereof, a cellulose acylate film having a thickness of equal to or less than 77 micro meters, and a layer having a negative photoelastic coefficient is disclosed.

### CROSS-REFERENCE TO RELATED APPLICATIONS

The present application claims the benefit of priority from Japanese Patent Application No. 2010-218302, filed on Sep. 29, 2010, the contents of which are herein incorporated by reference in their entirety.

### BACKGROUND OF THE INVENTION

1. Field of the Invention

The present invention relates to a polarizing plate, and to a liquid crystal display device having it. More specifically, the present invention relates to a polarizing plate hardly causing light leakage due to its deformation depending on heat and moisture, and to a liquid crystal display device having it, which shows a high visual quality. The present invention relates also to a protective film having resistance to moisture and heat.

2. Background Art

Generally, a polarizing film, which is prepared by stretching polyvinyl alcohol absorbing iodine or the like, has been used in a polarizing plate. The polarizing plate generally has a laminate structure in which both surfaces of the polarizing film adhere to a protective film for protecting it. Cellulose triacetyl cellulose films, which are versatile, have been used as the protective film.

A liquid crystal display device, in which the polarizing plate is used, becomes thinner and thinner, and the clearance between the backlight and the display panel unit tends to become shorter and shorter. As a result, the polarizing plate disposed close to the backlight may deform due to heat from the backlight, which may be one of the factors lowering the visual quality. And the environment in which the device is used becomes diverse, and there is an increasing demand for the polarizing plate sufficient for being used in any environment of a high temperature and high moisture.

A polarizing plate having a polarizer, which is a polyvinyl alcohol film dyed by dichroic material, and a stretched polyethylene terephthalate film, disposed on at least one surface of the polarizer through a predetermined adhesive layer, has been provided as a polarizing plate having improved durability in a high-temperature environment (see JP-A-2009-282137). As described in JP-A-2009-282137, [0047], according to the means disclosed in the document, the durability of the polarizing plate in a high-temperature environment is improved by lowering the moisture percentage in the polarizer.

A polarizing plate having a polarizing film and a stretched polyethylene terephthalate, disposed on one surface of the polarizing film through a predetermined adhesive layer, has been proposed as a polarizing plate having excellent resistance to moisture and temperature (see JP-A-2010-91602). According to the means disclosed in JP-A-2010-91602, resistance of the polarizing plate to moisture and heat is improved by using the stretched polyethylene terephthalate film, which has a relatively-low moisture permeability, as a protective film, in place of the triacetyl cellulose film having a relatively-high moisture permeability.

A polarizing plate, comprising a polarizing film, a pressure-sensitive adhesive layer and an optical compensation sheet wherein the photoelastic coefficient of the pressure-sensitive adhesive layer and the modulus of elasticity of the optical compensation sheet fulfils the predetermined condition, has been proposed as a polarizing plate which is improved in terms of the light leakage caused by deformation depending on heat (see JP-A-2008-181105). As shown in FIGS. 1 and 2 of JP-A-2008-181105, the pressure-sensitive adhesive layer is used for bonding the lamination, containing the polarizing film and optical compensation sheet, to another member such as a liquid crystal cell.

### SUMMARY OF THE INVENTION

A cellulose-acylate film such as a triacetyl-cellulose-film, which has been used as a protective film of a polarizing plate, is available at low cost, and excellent in workability. Therefore, improvement in the moisture- and heat-resistance of the polarizing plate, still employing a cellulose acylate film as a protective film, is significantly beneficial in industry of the technical field.

One object of the invention is to provide the means capable of improving the moisture- and heat-resistance of a polarizing plate having a cellulose-acylate film as a protective film.

More specifically, one object of the invention is to provide

a polarizing plate containing a cellulose acylate film, which is improved in terms of resistance to moisture and heat,

a liquid crystal display device in which uneven brightness caused by heat or moisture is reduced, and

a protective film, showing resistance to moisture and heat, made of a cellulose acylate film.

The means for achieving the above-described object are as follows.

[1] A polarizing plate comprising:
a polarizing film, and on one surface thereof,
a cellulose acylate film having a thickness of equal to or less than 77 micro meters, and
a layer having a negative photoelastic coefficient.
   [2] The polarizing plate of [1], wherein an averaged elastic modulus of the cellulose acylate film along a cross direction and a longitudinal direction is equal to or more than 3800 MPa.
   [3] The polarizing plate of [1] or [2], wherein the layer having a negative photoelastic coefficient is an adhesive layer bonding the cellulose acylate film and the polarizing film.
   [4] The polarizing plate of [3], wherein the adhesive layer is formed of a composition comprising an acrylic adhesive.
   [5] The polarizing plate of [4], wherein the thickness of the adhesive layer is from 1 to 20 micro meters.
   [6] The polarizing plate of [1] or [2], wherein the layer having a negative photoelastic coefficient is a polymer film comprising a cycloolefinic polymer or an acrylic polymer.
   [7] A liquid crystal display device comprising:
a polarizing plate of any one of [1]-[6], and
a liquid crystal cell.
   [8] The liquid crystal display device of [7], wherein the polarizing plate is disposed at a backlight side.
   [9] The liquid crystal display device of [7] or [8], wherein a layer having a negative photoelastic coefficient and a cellulose acylate film in the polarizing plate are disposed between the liquid crystal cell and a polarizing film in the polarizing plate.
   [10] A moisture- and heat-resistant protective film to be used in a polarizing plate, comprising:
a cellulose acylate film having a thickness of equal to or less than 77 micro meters, and
a layer having a negative photoelastic coefficient.
   [11] The protective film of [10], wherein an averaged elastic modulus of the cellulose acylate film along a cross direction and a longitudinal direction is equal to or more than 3800 MPa.
   [12] The protective film of [10] or [11], wherein the layer having a negative photoelastic coefficient is a polymer film comprising a cycloolefinic polymer or an acrylic polymer.

According to the invention, it is possible to provide the means capable of improving the moisture- and heat-resistance of a polarizing plate having a cellulose-acylate film as a protective film.

More specifically, according to the invention, it is possible to provide

a polarizing plate containing a cellulose acylate film, which is improved in terms of resistance to moisture and heat,

a liquid crystal display device in which uneven brightness caused by heat or moisture is reduced, and

a protective film, showing resistance to moisture and heat, made of a cellulose acylate film.

### BRIEF DESCRIPTION OF THE DRAWINGS

FIG. 1 is a schematic cross-sectional view of one example of the polarizing plate of the invention.

FIG. 2 is a schematic cross-sectional view of another example of the polarizing plate of the invention.

In the drawings, the reference numerals and signs have the following meanings.
10, 10′ Polarizing plate
12 Polarizing film
14 Layer having a negative photoelastic coefficient
16 Cellulose acylate film having a thickness of equal to or less than 77 micro meters
18 Protective film

### DETAILED DESCRIPTION OF THE INVENTION

The present invention will be described in detail below. In this specification, a numerical range expressed by the terms “a number to another number” means a range falling between the former number indicating a lower limit value of the range and the latter number indicating an upper limit value thereof.

It is to be noted that in the specification, the terms of “adhesive” and “pressure-sensitive adhesive” are used distinctly. The term of “adhesive” is used for any agents capable of bonding two members by hardening via any chemical reaction or the like. The term of “pressure-sensitive adhesive” is used for any agents capable of bonding two members by high-viscosity thereof without undergoing the step of hardening. The state of an adhesive is changed during bonding. On the other hand, the state of an pressure-sensitive adhesive is not changed during bonding,

### 1. Polarizing Plate

The present invention relates to a polarizing plate comprising:
a polarizing film, and on one surface thereof,
a cellulose acylate film having a thickness of equal to or less than 77 micro meters, and
a layer having a negative photoelastic coefficient.

According to the invention, both of the cellulose acylate film having a positive photoelastic coefficient and the layer having a negative photoelastic coefficient are disposed on one surface of the polarizing film. Even if deformation of the polarizing plate is caused by moisture or heat from the backlight or the like, they are disposed so that birefringence developing in them can be offset by each other, which can reduce the variation in polarization characteristics caused by deformation. However, if the thickness of the cellulose acylate film is more than 77 micro meters, compensation of birefringence by the negative-photoelastic coefficient layer becomes insufficient, and the variation in polarization characteristics may be recognized practically. And if the thickness of the cellulose acylate film is more than 77 micro meters, the thick negative-photoelastic coefficient layer may be required, which may be disadvantageous in terms of cost and thinner thereof. According to the prior arts, the thicker cellulose acylate film or the like was considered more preferable for improving the resistance of the polarizing plate to moisture and heat. As contrasted with the prior arts, according to the invention, the resistance of the polarizing plate to moisture and heat is improved by using a cellulose acylate film, of which thickness is equal to or less than 77 micro meters, in combination with a negative-photoelastic coefficient layer, as a protective film.

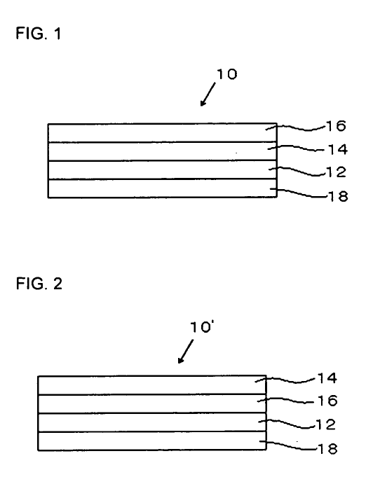

The schematic cross-sectional views of first and second examples of the polarizing plate of the invention are shown in FIG. 1 and FIG. 2 respectively. It is to be noted that the relative relation between the thicknesses of layers in FIG. 1 may not be same as the real relation. The same applies to FIG. 2.

The polarizing plate 10, shown in FIG. 1, has a polarizing film 12, a negative-photoelastic coefficient layer 14 and a cellulose acylate film 16, which are disposed on a surface of the polarizing film 12, and a protective film 18, which may be selected from any polymer films, disposed on another surface of the polarizing film 12. The polarizing plate 10′, shown in FIG. 2, has a same structure as that of the polarizing plate 10, except that a negative-photoelastic coefficient layer 14 and a cellulose acylate film 16 are exchanged.

In both of the polarizing plates 10 and 10′ shown in FIG. 1 and FIG. 2 respectively, the thickness of the cellulose acylate film 16 is equal to or less than 77 micro meters. The cellulose acylate film 16 may function as a protective film of the polarizing film 12 or as a part of a protective film of the polarizing film 12. The cellulose acylate film 16 has a positive-photoelastic coefficient. Birefringence developing due to deformation caused by heat and/or moisture may be one of the factors of causing light-leakage. It is possible to compensate birefringence caused by deformation of the cellulose acylate film 16 or the like since there is a negative-photoelastic coefficient layer 14 in the polarizing plate 10 or 10′. The cellulose acylate film which can be used in the invention will be described in detail later.

The polarizing plate 10, or the first example of the invention, shown in FIG. 1, has the negative-photoelastic coefficient layer 14 which is disposed between the cellulose acylate film 16 and the polarizing film 12. According to the example, the negative-photoelastic coefficient layer 14 may be an adhesive layer for bonding the cellulose acylate film 16 to the polarizing film 12. If the negative-photoelastic coefficient layer 14 is an adhesive layer, it is possible to make the polarizing plate thinner, which is preferable. Examples of the material, which can be used for an adhesive layer having a negative-photoelastic coefficient, include an acrylic adhesive. The materials which can be used for preparing the adhesive layer having a negative-photoelastic coefficient will be described in detail later.

Of course, in the first example shown in FIG. 1, the negative-photoelastic coefficient layer 14 may be a polymer film having a negative-photoelastic coefficient.

The polarizing plate 10′, or the second example of the invention, shown in FIG. 2, has the negative-photoelastic coefficient layer 14 which is disposed on the cellulose acylate film 16. According to the example, the negative-photoelastic coefficient layer 14 may be a polymer film having a negative-photoelastic coefficient. Examples of the material which can be used for preparing the polymer film having a negative-photoelastic coefficient include a cycloolefinic polymer or an acrylic polymer. These materials will be described in detail later.

Examples of the polarizing plate of the invention are not limited to those having the same structure as that shown in FIG. 1 or FIG. 2. The polarizing plate may have, if necessary, one or more other functional layers such as an anti-reflection layer, an optically anisotropic layer, an anti-static layer and a hard coating layer. The polarizing plate may have any adhesive layer disposed between the layers. The polarizing plate may have any pressure-sensitive adhesive layer to be used for bonding to a liquid crystal cell, disposed as an outermost layer.

Next, examples of the material and the process which can be used for preparing the polarizing plate of the invention will be described in detail.

### (1) Cellulose Acylate Film

The polarizing plate of the invention has a cellulose acylate film as a protective film of a polarizing film or as a part of a protective film of a polarizing film. In the specification, the term “cellulose acylate film” is used for any films containing one or more cellulose acylate(s) as a major ingredient. Here, the term “includes as a main ingredient” means the cellulose acylate when one kind of cellulose acylate is used as a material of the cellulose acylate film, and means the cellulose acylate contained in a highest ratio when plural kinds of cellulose acylates are used as a material of the film.

The cellulose acylate film which can be used in the invention has a positive-photoelastic coefficient. The photoelastic coefficient of the cellulose acylate film may be from about 5×10⁻¹² Pa⁻¹ to about 25×10⁻¹² Pa⁻¹, from about 10×10⁻¹² Pa⁻¹ to about 20×10⁻¹² Pa⁻¹, or from about 12×10⁻¹² Pa⁻¹ to about 18×10⁻¹²Pa⁻¹. The photoelastic coefficient of the cellulose acylate film may be decided depending on plural factors such as the type of the cellulose acylate to be used as a main ingredient and an amount thereof, the type of the additive and an amount thereof, the thickness, and the process to be used for preparing the film, and the condition in the process. The cellulose acylate film having the photoelastic coefficient falling within the above-described range may be obtained by adjusting these factors.

The photoelastic coefficient of a cellulose acylate film sample can be known by measuring retardation of the sample using an ellipsometer (M-150 available from JASCO Corporation) while the sample is subjected to a load. The photoelastic coefficient of the negative-photoelastic coefficient layer can be also known according to the same method.

The cellulose acylate film to be used in the invention has a thickness of equal to or less than 77 micro meters, preferably equal to or less than 60 micro meters, or more preferably equal to or less than 45 micro meters. According to the invention, birefringence caused by deformation of the cellulose acylate film, having a positive-photoelastic coefficient, is compensated by the negative-photoelastic coefficient layer. If the thickness of the cellulose acylate film is beyond the above-described range, the compensation may be insufficient, and debasement of the visual quality may be recognizable, which is not of practical use. Although there may be no lower limit of the thickness of the cellulose acylate film, in general, the thickness of a self-supportable film may be equal to or more than 20 micro meters.

No limitation may be made on cellulose acylates to be used as a raw material of the cellulose acylate film. Any cellulose acylates may be used as far as they can form a transparent film. Any cellulose acylates which are prepared from any raw cellulose such as cotton linter and wood pulp (e.g., broadleaf pulp, conifer pulp) may be used; and, if necessary, one or more raw cellulose may be combined. The details of these cellulose materials are described, for example, in Marusawa & Uda's “Plastic Material Lecture (17), Cellulosic Resin”, Nikkan Kogyo Newspaper (1970), and Hatsumei Kyokai Disclosure Bulletin 2001-1745 (pp. 7-8).

The raw cellulose acylate may be selected from cellulose acylates with a mono-type acyl group or from cellulose acylates with a plural-type acyl group. The cellulose acylate having one or more C₂₋₄ acyl groups are preferable. If the cellulose acylate having plural types of acyl groups is used, one of the acyl group is preferably an acetyl. As the C₂₋₄ acyl group, propionyl or butyryl is preferable. The cellulose acylates having such an acyl group may exhibit a good solubility, and a suitable solution to be used for preparing the film may be prepared by dissolving the cellulose acylates having such an acyl group in a solvent especially such as non-chlorine based solvent. Furthermore, the solution having a low viscosity and good-filtration property may be prepared.

A cellulose has free hydroxyl groups at 2-position, 3-position and 6-position per a unit of glucose having a β-1,4 bonding. Cellulose acylates are polymers obtained by acylation for a part or all of these hydroxyls. The degree of acyl-substitution means the total ratios of acylation for each of the 2-, 3- and 6-position-hydroxyls in a cellulose molecule. The degree of acyl-substitution is 1 when the ratio of acylation for each of the 2-, 3- and 6-position-hydroxyls is 100%.

Examples of the C₂ or longer acyl group include an aliphatic acyl group and an aryl acyl group. Examples of the cellulose acylate include alkyl carbonyl esters, alkenyl carbonyl esters, aromatic carbonyl esters, and aromatic alkyl carbonyl esters of cellulose, and they may have at least one substituent. Preferable examples of the acyl group include acetyl, propionyl, butanoyl, heptanoyl, hexanoyl, octanoyl, decanoyl, dodecanoyl, tridecanoyl, tetradecanoyl, hexadecanoyl, octadecanoyl, isobutanoyl, tert-butanoyl, cyclohexane carbonyl, oleoyl, benzoyl, naphthyl carbonyl, and cinnamoyl. Among these, acetyl, propionyl, butanoyl, dodecanoyl, octadecanoyl, tert-butanoyl, oleoyl, benzoyl, naphthyl carbonyl, and cinnamoyl are more preferable; acetyl, propionyl and butanoyl, each of which is C₂₋₄ acyl group, are even more preferable; and acetyl is especially preferable, or that is, cellulose acetate is especially preferable as the cellulose acylate.

In acylation of cellulose, when an acid anhydride or an acid chloride is used as the acylating agent, the organic solvent as the reaction solvent may be an organic acid, such as acetic acid, or methylene chloride or the like.

When the acylating agent is an acid anhydride, the catalyst is preferably a protic catalyst such as sulfuric acid; and when the acylating agent is an acid chloride (e.g., CH₃CH₂COCl), a basic compound may be used as the catalyst.

A most popular industrial production method for a mixed fatty acid ester of cellulose comprises acylating cellulose with a fatty acid corresponding to an acetyl group and other acyl groups (e.g., acetic acid, propionic acid, valeric acid, etc.), or with a mixed organic acid ingredient containing their acid anhydride.

Examples of the process for preparing the cellulose acylate which can be used in the invention include the process disclosed in JP-A-10-45804.

One example of the cellulose acylate which can be used in the invention is a cellulose acylate film which consists of or contains a low-substitution layer containing a cellulose acylate fulfilling the condition of formula (I) as a major ingredient.

2.0<Z1<2.7 (1)

In formula (1), Z1 represents a total degree of acylation of the cellulose acylate used as the main ingredient of the low-substitution layer.

The low-substitution layer may have a high-substitution layer, on one surface thereof, containing a cellulose acylate fulfilling the condition of formula (2) as a main ingredient.

2.7<Z2 (2)

In formula (2), Z2 represents a total degree of acylation of the cellulose acylate used as the main ingredient of the high-substitution layer.

Examples of the cellulose acylate to be used in the low-substitution layer include cellulose acylates fulfilling the conditions of formulae (3) and (4).

1.0<X1<2.7 (3)

In formula (3), X1 represents a degree of acetylation of the cellulose acylate used as the main ingredient of the low-substitution layer.

0≦Y1<1.5 (4)

In formula (4), Y1 represents a total degree of acyl-substitution having 3 or more carbon atoms of the cellulose acylate used as the main ingredient of the low-substitution layer.

It is to be noted that X1 and Y1 along with Z1 in formula (1) described above fulfill the condition of “X1+Y1=Z1”.

Examples of the cellulose acylate to be used in the high-substitution layer include cellulose acylates fulfilling the conditions of formulae (5) and (6).

1.2<×2<3.0 (5)

In formula (5), X2 represents a degree of acetylation of the cellulose acylate used as the main ingredient of the high-substitution layer.

0≦Y2<1.5 (6)

In formula (6), Y2 represents a total degree of acyl-substitution having 3 or more carbon atoms of the cellulose acylate used as the main ingredient of the high-substitution layer.

It is to be noted that X2 and Y2 along with Z2 in formula (2) described above fulfill the condition of “X2+Y2=Z2”.

The cellulose acylate film may, if necessary, contain at least one additive. Examples of the additive include plasticizers, agent for controlling optical properties (e.g. agents controlling wavelength-dispersion of retardation, retardation enhancers and retardation reducers), fine particles, UV absorbers and antioxidants.

The cellulose acylate film may be prepared according to a solution film-forming method or a melt film-forming method. Commercially available cellulose acylate films may be used as far as their thicknesses fall within the above-described range. The cellulose acylate film may be selected from stretched films subjected to a stretching treatment. More specifically, the cellulose acylate film may be selected from any stretched cellulose acylate films such as uniaxially-stretched and biaxially-stretched cellulose acylate films. It is possible to adjust the thickness of the film to the above-described range by stretching.

According to the embodiment wherein the cellulose acylate film is used for optically compensating birefringence of a liquid crystal cell, the cellulose acylate film preferably exhibits retardation capable of contributing the optical compensation; and it is possible to adjust retardation of the film to the preferable range by stretching.

According to the invention, the cellulose acylate film having a higher elastic modulus is more preferable in terms of reduction of deformation caused by moisture or heat. More specifically, an averaged elastic modulus of the cellulose acylate film along a cross direction and a longitudinal direction is preferably equal to or more than 3800 MPa, more preferably equal to or more than 4000 MPa, or even more preferably equal to or more than 4200 MPa. Although there may be no upper limit of the averaged elastic modulus, in general, the averaged elastic modulus of a cellulose acylate film may be less than 6000 MPa. The averaged elastic modulus of the cellulose acylate film along a cross direction and a longitudinal direction may be measured as follows.

At first, a cellulose acylate film sample 10 mm×150 mm is prepared. The sample is conditioned at 25 degrees Celsius and RH 60% for 2 hour or longer, and then the elastic moduls of the sample is measured with a tensile tect machine (STROGRAPHY R2 manufactured by Toyo Seiki Kogyo Co.) at a distance between chucks of 50 mm, at a temperature of 25 degrees Celsius, and at a stretching speed of 10 mm/min. The elastic modulus along the cross direction is measured while the sample, having a length of 150 mm along the cross direction and a length of 10 mm along the longitudinal direction, is drawn along the cross direction; and the elastic modulus along the longitudinal direction is measured while the sample, having a length of 10 mm along the cross direction and a length of 150 mm along the longitudinal direction, is drawn along the longitudinal direction. Then, the averaged elastic modulus of the cellulose acylate film along a cross direction and a longitudinal direction is calculated on the basis of these values.

In general, a long cellulose acylate film, prepared while being fed continuously, may have the elastic modulus, which are different from each other, along the machine direction (MD) and the direction perpendicular thereto (TD); and the cellulose acylate film, having the averaged elastic modulus falling within the above-described range along the MD and the TD, is preferably used in the invention.

The cellulose acylate film to be used in the invention may not be limited in terms of optical properties. According to the embodiment wherein the polarizing plate of the invention is disposed so that the cellulose acylate film is between the liquid crystal cell and the polarizing film, retardation of the cellulose acylate film may affect the visual quality, and therefore, retardation in plane Re and retardation along the thickness Rth of the film is preferably adjusted to any preferable range depending on the mode of the liquid crystal cell. Preferable ranges of Re and Rth in the embodiment wherein the polarizing plate of the invention is disposed so that the cellulose acylate film is between the liquid crystal cell and the polarizing film are exemplified with respect to each of the modes as follows. However, the ranges of Re and Rth are not limited to the following ranges.

In the embodiment wherein the polarizing plate of the invention is disposed on the backlight-side of a VA mode liquid crystal cell, Re of the celluloe acylate film is preferably from 20 to 100 nm (more preferably from 40 to 80 nm), and Rth of the celluloe acylate film is preferably from 100 to 300 nm (more preferably from 150 to 250 nm). According to the embodiment, among two protective films of another polarizing plate, one disposed between the liquid crystal cell and the polarizing film is preferably optically isotropy.

In the embodiment wherein the polarizing plate of the invention is disposed on both of the visual surface-side and the backlight-side of a VA mode liquid crystal cell, Re of the celluloe acylate film is preferably from 20 to 80 nm (more preferably from 30 to 60 nm), and Rth of the celluloe acylate film is preferably from 80 to 200 nm (more preferably from 110 to 170 nm).

In the embodiment wherein the polarizing plate of the invention is disposed on both of the visual surface-side and the backlight-side of an IPS mode liquid crystal cell, Re of the celluloe acylate film is preferably from 0 to 10 nm (more preferably from 0 to 6 nm), and Rth of the celluloe acylate film is preferably from 0 to 50 nm (more preferably from 0 to 20 nm).

The cellulose acylate film is preferably subjected to a surface treatment in terms of improvement of the adhesion to the negative-photoelastic coefficient layer and/or the polarizing film. Examples of the surface treatment include acorona discharge treatment, a glow discharge treatment, a flame treatment, an acid treatment, an alkali treatment and an ultraviolet irradiation treatment.

### (2) Negative-Photoelastic Coefficient Layer

The polarizing plate of the invention has a layer having a negative-photoelastic coefficient. The photoelastic coefficient of the layer is preferably from −20×10⁻¹²Pa⁻¹ to −2×10⁻¹²Pa⁻¹, more preferably from −15×10⁻¹²Pa⁻¹ to 2×10⁻¹²Pa⁻¹, or even more preferably from −10×10⁻¹² Pa⁻¹ to −3×10⁻¹² Pa⁻¹. By using the layer having the photoelastic coefficient falling within the above-described range, it is possible to sufficiently compensate birefringence caused by deformation of the cellulose acylate film.

The materials to be used for preparing the negative-photoelastic coefficient layer are not limited as far as they can form a transparent layer having a negative-photoelastic coefficient. The layer may be a layer which is prepared by coating such as an adhesive layer or a self-supportable polymer film.

Examples thereof will be described in detail respectively.

### Adhesive Layer:

The negative-photoelastic coefficient layer may be an adhesive layer. The negative-photoelastic coefficient layer is preferably an adhesive layer which is disposed between the polarizing film and the cellulose acylate film so as to bond them. Examples of the negative-photoelastic coefficient layer include any adhesive layers formed of an acrylic adhesive composition. It is to be noted that a polyvinyl alcohol-base adhesive composition, which has often been used for bonding a cellulose acylate film and a polarizing film, cannot form any negative-photoelastic coefficient layer.

Examples of the acrylic adhesive include acrylic acid or methacrylic acid (the term “(meth)acrylic acid” is used as an all-inclusive term.) and any derivatives thereof (including esters of (meth)acrylic acid), and reactive adhesives containing polymers of (meth)acrylic acid or any derivatives thereof as a major ingredient. One example thereof is an acrylic adhesive containing an acrylic polymer and a crosslinkable agent, and the acrylic polymer is prepared by carrying out a radical polymerization of an acrylic monomer composition, containing an ester of (meth)acrylic acid as a major ingredient and containing a (meth)acrylic monomer having a functional group in a small amount, in precense of a polymerization initiator. Examples of the ester of (meth)acrylic acid, or a major ingredient of the acrylic polymer, include those represented by the following formula.

CH₂═C(R¹)COOR²

In the formula, R¹ represents a hydrogen atom or methyl; R² represents a C₁₋₁₄ alkyl or aralkyl; and one or more hydrogen atoms in alkyl represented by formula R² may be replaced with a C₁₋₁₀ alkoxy.

Examples of the ester of (meth)acrylic acid include butyl acrylate having R¹ of H and R² of n-butyl, and 2-ethylhexyl acrylate having R¹ of H and R² of 2-ethylhexyl.

Examples of the (meth)acrylic monomer having a functional group, which can be used for preparing the acrylic polymer, include monomers having any polar functional group such as hydroxy, carboxy, amino and epoxy, and an olefinic double bond (usually, (meth)acryloyl). Specific examples of the monomer, having hydroxy, include 2-hydroxyethyl (meth)acrylate; and specific examples of the monomer, having carboxyl, include acrylic acid.

A small amount of any monomer having plural (meth)acryloyl groups may be co-polymerized to prepare the acrylic polymer; and examples of such a monomer include 1,4-butanediol di(meth)acrylate.

In preparation of the acrylic polymer to be a major ingredient of the adhesive, one type of the (meth)acrylate and one type of the (meth)acrylic monomer having a functional group may be used respectively, or two types of the (meth)acrylate and two types of the (meth)acrylic monomer having a functional group may be used respectively. Or any combinations of two or more types of acrylic polymer, which is a copolymer of (meth)acrylate and (meth)acrylic monomer having a functional group, may be used for preparing the acrylic polymer composition which is a polymer ingredient of the adhesive. Or any combinations of the copolymer and other acrylic polymer(s) such as a homopolymer or copolymer of (meth)acrylic acid having no functional group may be used for preparing the acrylic polymer composition which is a polymer ingredient of the adhesive.

Examples of the crosslinkable agent which may be added to the acrylic adhesive include isocyanate series compounds, epoxy compounds, metal-chelate compounds and aziridine compounds. Examples of the isocyanate compound which can be used in the invention include not only compounds having at least two isocyanate groups (—NCO) but also adducts, which are obtained by reacting the isocyanate compound with polyol or the like, and dimers and trimers thereof. Examples of the crosslinkable isocyanate compound include trimethylolpropane adducts of hexamethylene diisocyanate, and trimethylolpropane adducts of tolylene diisocyanate; and they may be used as a solution of organic solvent such as ethyl acetate thereof. The crosslinkable agent may be used alone or in combination of plural types thereof.

The weight-averaged molecular weight of the acrylic polymer which can be used in the acrylic adhesive is, as a polystyrene-equivalent value by the gel permeation chromatography (GPC), preferably from about 600,000 to about 2,000,000, or more preferably from 800,000 to 1,800,000.

An acrylic adhesive solution may be prepared by dissolving the acrylic polymer in an organic solvent such as ethyl acetate and then adding a crosslinkable agent thereto. If necessary, one or two selected from the group consisting of a silane coupling agent, a weathering stabilizer, a tackifier, a plasticizer, a softener, a pigment and light-scattering particles such as inorganic filler or organic beads may be added to the solution.

The adhesive layer may be prepared as follows. The adhesive composition prepared as a coating liquid, containing acrylic adhesive or the like, is applied to a surface of the cellulose acylate film or the polarizing film and then, is hardened by evaporating the solvent, if necessary, under heat. The adhesive layer may be formed on a temporary support, and then, may be transferred onto the surface of the cellulose acylate film or the polarizing film.

Although the thickness of the adhesive layer is not limited, in general, the thickness of the layer is preferably from 0.1 to 40 micro meters, more preferably from 1 to 20 micro meters, or even more preferably from 3 to 15 micro meters.

### Polymer Film:

The negative-photoelastic coefficient layer may be a polymer film. Examples of the negative-photoelastic coefficient layer include, but are not limited, (1) polymer films containing at least one cycloolefinic polymer, and (2) polymer films containing at least one acrylic polymer having at least a unit selected from the unit group consisting of lactone ring unit, maleic acid anhydrideunit, and glutaric acid anhydride unit.

### (1) Polymer Film Containing at Least One Cycloolefinic Polymer

Examples of the cycloolefinic polymer to be used for preparing the polymer film (occasionally referred to as “cycloolefinic polymer film”), which can be used in the invention, containing at least one cycloolefinic polymer as a major ingredient, include norbornene polymers, polymers of monocycloolefin, polymers of cyclic conjugated diene, vinyl-alicyclic hydrocarbon polymers, and any hydrogenated products thereof. Preferable examples thereof include cycloolefinic addition (co)polymers having at least one repetitive unit represented by formula (II), and cycloolefinic addition (co)polymers having also at least one repetitive unit represented by formula (1) along with the at least one repetitive unit represented by formula (II). Other preferable examples thereof include ring-opening (co)polymers having at least one repetitive cyclic unit represented by formula (III).

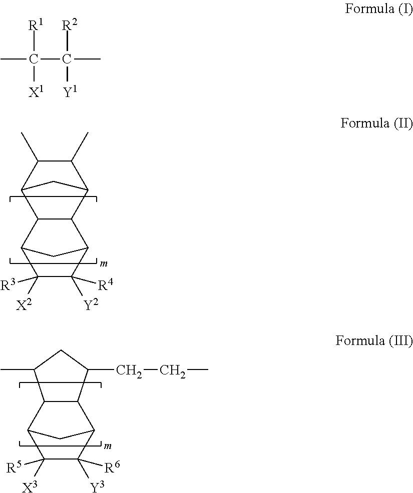

In the formulae, m represents an integer from 0 to 4. R¹-R⁶ represent a hydrogen atom or a C₁₋₁₀ hydrocarbon group respectively; X¹-X³ and Y¹-Y³ represent a hydrogen atom, C₁₋₁₀ hydrocarbon group, halogen atom, C₁₋₁₀ hydrocarbon group having one or more halogen atoms, —(CH₂)ₙCOOR¹¹, —(CH₂)ₙOCOR¹², —(CH₂)ₙNCO, —(CH₂)ₙNO₂, —(OH₂)ₙCN, —(CH₂)ₙCONR¹³R¹⁴, —(CH₂)ₙNR¹³R¹⁴, —(CH₂)ₙOZ, or —(CH₂)ₙW respectively, or X¹ and Y¹, X² and Y² or X³ and Y³ form a group of (—CO)₂O or (—CO)₂NR¹⁵. R¹¹, R¹², R¹³, R¹⁴ and R¹⁵ represents a hydrogen atom or C₁₋₂₀ hydrocarbon group respectively; Z represents a hydrocarbon group or a halogenated hydrocarbon group; W represents SiR¹⁶ₚD₃₋ₚ(R¹⁶ represents a C₁₋₁₀ hydrocarbon group; D represents a halogen atom, —OCOR¹⁶ or —OR¹⁶; and p is an integer of from 0 to 3); and n represents an integer of from 0 to 10.

Norbornene-series addition (co)polymers are disclosed in for example JP-A-Hei 10-7732, Tokuhyo 2002-504184, US 2004 229157A or WO 20041070463A1. Such norbornene-series addition (co)polymers may be obtained by addition polymerization of norbornene-series polycyclic unsaturated compounds. If necessary, further, norbornene-series polycyclic unsaturated compounds may be addition polymerized with conjugated dienes such as ethylene, propylene, butane, butadiene and isoprene; non-conjugated dienes such as ethylidene norbornene; and linear diene compounds such as acrylonitrile, acrylic acid, methacrylic acid, maleic anhydride, acrylate esters, methacrylate esters, maleimide, vinyl acetate and vinyl chloride. The norbornene-series addition (co)polymers are commercially available from Mitsui Chemical Co., Ltd. under the product name of Apel series with different glass transition temperatures (Tg), including for example APL 8008T (Tg=70 degrees Celsius), APL6013T (Tg=125 degrees Celsius) or APL6015T (Tg=145 degrees Celsius). Pellets of such copolymers are commercially available from Polyplastics Co., Ltd., including for example TOPAS 8007, TOPAS 6013 and TOPAS 6015. Furthermore, Appear 3000 is also commercially available from Ferrania Technologies.

As disclosed in JP-A-Hei 1-240517, JP-A-Hei 7-196736, JP-A-Sho 60-26024, JP-A-Sho 62-19801, JP-A-2003-159767 or JP-A-2004-309979, hydrogenated norbornene-series polymers are produced by addition polymerization or ring opening metathesis polymerization of polycyclic unsaturated compounds and subsequent hydrogenation.

In the norbornene-series polymers for use in accordance with the invention, R⁵ and R⁶ are preferably hydrogen atom or —CH₃; X³ and Y³ are preferably hydrogen atom, Cl or —COOCH₃; and other groups are appropriately selected optionally. The norbornene-series resins are commercially available, from JSR under the trade name of Arton G or Arton F and from Zeon Corporation under the trade names of Zeonor ZF14 and ZF 16 or under the trade name of Zeonex 250 or Zeonex 280. These may also be used.

The cycloolefinic polymer film may be prepared according to a solution film-forming method or a melt film-forming method. One example of the process for preparing the film is as follows. A solution (dope) is prepared by dissolving the cycloolefinic polymer in an organic solvent, and, using the dope, the film is prepared according to a solution film-forming method. Fine particles may be dispersed in the dope. Examples of the fine particles include inorganic fine particles and fine particles of polymer compounds. Examples of the inorganic fine particles include micronized inorganic compounds such as balium sulfate, manganese colloid, titanium dioxide, strontium balium sulfate, and silicon dioxide, and further, include silicon dioxide such as synthesis silica obtained by a wetting method or gelation of silicic acid and titanium dioxide formed from a titanium slug and sulfuric acid (rutile type or anatase type). Further, they can also be obtained by classification (vibratory filtration, pneumatic classification, etc.) after pulverization from inorganic materials of relatively large particle size, for example, of 20 micro meters or more. Inorganic fine particles are preferably those containing silicon in that the turbidity is lowered and the haze of the film can be lowered. Many particles of silicon dioxide which are subjected to a surface treatment with organic materials are provided, and they are preferred since they can lower the surface haze of the film. Preferable examples of the organic material to be used for the surface treatment include halosilanes, alkoxy silanes, silazanes, and siloxanes. Examples of the polymer compound include polytetrafluoroethylene, cellulose acetate, polystyrene, polymethylmethacrylate, polypropylmethacrylate, polymethylacrylate, polyethylenecarbonate and starch; and pulverization-classified products thereof may also be used. Or, any polymer compounds prepared according to a suspension polymerization method, any polymer compounds subjected to a spheronization treatment according to a spray-dry or dispersion method, and any inorganic compound particles may be used.

Regarding the method of preparing a dope, the process of preparing a polymer film according to a solution film-forming method using the dope, the details are described in JP-A-2007-77243, and they may be be referred to.

### (2) Polymer Film Containing at Least One Acrylic Polymer

Examples of the aclylic polymer to be used for preparing the polymer film (occasionally referred to as “aclylic polymer film”), which can be used in the invention, containing at least one acrylic polymer as a major ingredient, include any acrylic polymers having at least a unit selected from the unit group consisting of lactone ring unit, maleic acid anhydride unit, and glutaric acid anhydride unit.

The acrylic polymer may be selected from any polymers obtained by promerization of any monomer composition containing (meth)acrylate as a major ingredient. The aclylic polymer film may contain two or more types of acrylic polymer as a major ingredient. Examples of the (meth)acrylate include those represented by formula (10).

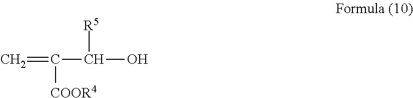

In the formula, R⁴ and R⁵ each independently represent a hydrogen atom or C₁₋₂₀ organic group. Examples of the compound represented by the fromula include 2-(hydroxymethyl)methyl acrylate, 2-(hydroxymethyl)ethyl acrylate, 2-(hydroxymethyl)isopropyl acrylate, 2-(hydroxymethyl)n-butyl acrylate, and 2-(hydroxymethyl)tert-butyl acrylate. Among these, 2-(hydroxymethyl)methyl acrylate and 2-(hydroxymethyl)ethyl acrylate are preferable. In terms of obtaining a high effect of improving heat-resistance, 2-(hydroxymethyl) methyl acrylate is especially preferable. The compound represented by formula (2) may be used alone or in combination with other compound(s) represented by formula (2).

Other examples of ester of (meth)acrylic acid include acrylates such as methyl acrylate, ethyl acrylate, n-butyl acrylate, iso-butyl acrylate, t-butyl acrylate, cyclohexyl acrylate and benzyl acrylate, and methacrylate such as methyl methacrylate, ethyl methacrylate, n-butyl methacrylate, iso-butyl methacrylate, t-butyl methacrylate, cyclohexyl methacrylate and benzyl methacrylate. These may be used alone respectively or in combination with other(s).

Among these, in terms of the high heat-resistance or the high transparency, the compound represented by fromula (10) or methyl methacrylate is preferable. Or, if large positive birefringence (positive retardation) is desired, benzyl (meth)acrylate is preferable.

The acrylic polymer may have other unit(s) along with the unit derived from the above-described ester of (meth)acrylic acid. More specifically, examples of the other unit include the units derived from a hydroxy-containing monomer, unsaturated carboxylic acid and a monomer represented by formula (11) shown below.

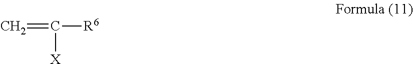

In the formula, R⁶ represents a hydrogen atom or methyl; X represents a hydrogen atom, C₁₋₂₀ alkyl, aryl, —OAc, —CN, —CO—R⁷, or —C—O—R⁸; Ac represents an acetyl; and R⁷ and R⁸ represent a hydrogen atom or a C₁₋₂₀ organic group respectively.

The hydroxy-containing monomer may be selected from any hydroxy-containing monomers which are other than the compound represented by formula (10), and examples of the hydroxy-containing monomer include allyl alcohols such as methallyl alcohol, allyl alcohol and 2-hydroxymethyl-1-butene, α-hydroxymethyl styrene, α-hydroxyethyl styrene, 2-(hydroxyalkyl)acrylates such as 2-(hydroxyethyl)methyl acrylate, and 2-(hydroxyalkyl)acrylic acid such as 2-(hydroxyethyl)acrylic acid. These may be used alone respectively, or in combination with other(s) of these.

Examples of the unsaturated carboxylic acid include acrylic acid, methacrylic acid, crotonic acid, α-substituted acrylic acid and α-substituted methacrylic acid, and these may be used alone respectively, or in combination with other(s) of these. Among these, acrylic acid and methacrylic acid are preferable in terms of obtaining the high effect of the invention.

Examples of the compound represented by formula (11) include styrene, vinyl toluene, α-methyl styrene, acrylonitrile, methylvinylketone, ethylene, propylene and vinyl acetate. These may be used alone respectively, or in combination with other(s) of theses. Among these, styrene and α-methyl styrene are especially preferable.

The acrylic polymer film may be prepared according to a solution film-forming method or a melt film-forming method. One example of the film is prepared according to a melt film-forming method. Regarding the acrylic polymer, or the material which can be used for preparing the acrylic polymer film, and the process for preparing the acrylic polymer film according to a melt film-forming method, the details are described in JP-A-2008-9378, and they may be referred to.

Although the thickness of the polymer film to be used as the negative-photoelastic coefficient layer is not limited, in general, the thickness of the polymer film is from 20 to 55 micro meters, or more preferably from 30 to 45 micro meters.

The polymer film to be used as the negative-photoelastic coefficient layer may contain at least one additive along with the major ingredient-polymer. Examples of the additive which can be used include those exemplified as the additive which can be added to the cellulose acylate film.

The polymer film to be used as the negative-photoelastic coefficient layer may be optically isotropic or anisotropic. If any optically anisotropic polymer film is used, it may affect optical compensation according to some configurations. Therefore, in such a case, the preferable ranges of the optical properties of the polymer film may be decided depending on the optical properties of the cellulose acylate film.

### Polarizing Film:

The polarizing plate of the invention contains a polarizing film. The polarizing film is not limited. Examples of a polarizing film include an iodine-base polarizing film, a dye-base polarizing film with a dichroic dye, and a polyene-base polarizing film, and any of these is usable in the invention. The iodine-base polarizing film and the dye-base polarizing film may be produced generally by absorbing iodine or dichroic dye to a polyvinyl alcohol film and then stretching it.

The polarizing plate of the invention may have a structure in which the cellulose acylate film and the negative-photoelastic coefficient layer are disposed on a surface of the polarizing film, and the cellulose acylate film may function as a protective film of the polarizing film alone or in combination of the negative-photoelastic coefficient layer such as the polymer film. A protective film is preferably disposed on another surface of the polarizing film. The polarizing plate of the invention is preferably integrated into a liquid crystal display device so that the cellulose acylate film and the negative-photoelastic coefficient layer are disposed between the polarizing film and the liquid crystal cell.

The protective film disposed on another surface of the poralizing film is not limited. It may be selected from any polymer films depending on its application. In some applications, the polymer film excellent in optical transparency, mechanical strength, heat-stability, water-sielding ability, isotropy or the like may be needed. Examples of the major ingredient of the polymer film include cellulose acylate, polycarbonate-base polymer, polyester-base polymers such as polyethylene terephthalate and polyethylene naphthalate, acryl-base polymers such as polymethylmethacrylate, and styrene-base polymers such as polystyrene and acrylonitrile.styrene copolymer (AS resin). Examples thereof include also polyolefins such as polyethylene and polypropylene, polyolefin-base polymers such as ethylene.propylene copolymer, vinyl chloride-base polymers, amide-base polymers such as nylon and aromatic polyamide, imide-base polymers, sulfone-base polymers, polyethersulfone-base polymers, polyether ether ketone-base polymers, polyphenylene sulfide-base polymers, vinylidene chloride-base polymers, vinyl alcohol-base polymers, vinyl butyral-base polymers, arylate-base polymers, polyoxymethylene-base polymers, epoxy-base polymers, and any combinations thereof. Commercially available polymer films may be used.

### Process for Preparing Polarizing Plate:

The process for preparing the polarizing plate of the invention is not limited. The polarizing plate may be prepared continuously as a long shape. The embodiment wherein the negative-photoelastic coefficient layer is an adhesive layer may be prepared by bonding the cellulose acylate film and the polarizing film via the adhesive layer formed on the surface of the cellulose acylate film or the polarizing film. A protective film may be bonded to another surface of the polarizing film at the same time, after or before bonding the cellulose acylate and the polarizing film. The embodiment wherein the negative-photoelastic coefficient layer is a polymer film may be prepared by bonding the negative-photoelastic coefficient polymer film to the cellulose acylate film after bonding the cellulose acylate film and the polarizing film, or by bonding the negative-photoelastic coefficient polymer film to the polarizing film after bonding the cellulose acylate film and the negative-photoelastic coefficient polymer film. According to the latter embodiment, the surface of the cellulose acylate film may be bonded to the surface of the polarizing film or the surface of the negative-photoelastic coefficient polymer film may be bonded to the surface of the polarizing film.

### 2. Liquid Crystal Display Device

The present invention relates to a liquid crystal display device having the polarizing plate of the invention. Since the polarizing plate of the invention hardly deforms by moisture or heat, the polarizing plate of the invention is preferably disposed on the backlight side where heat would easily affect. Furthermore, the cellulose acylate film and the negative-photoelastic coefficient layer of the polarizing plate are preferably disposed between the liquid crystal cell and the polarizing film. The liquid crystal display device of the invention may employ any mode such as a TN(Twisted Nematic), IPS(In-Plane Switching), FLC(Ferroelectric Liquid Crystal), AFLC(Anti-ferroelectric Liquid Crystal), OCB(Optically Compensatory Bend), STN(Supper Twisted Nematic), VA(Vertically Aligned), and HAN(Hybrid Aligned Nematic) mode. The effect of reducing the light leakage caused by heat or moisture can be obtained according to any liquid crystal display devices employing any mode.

### 3. Moisture- and Heat-Resistant Protective Film for Polarizing Plate

The present invention relates to a moisture- and heat-resistant protective film to be used in a polarizing plate, comprising a cellulose acylate film having a thickness of equal to or less than 77 micro meters, and a layer having a negative photoelastic coefficient. By using the protective film of the invention, it is possible to reduce deformation of the polarizing plate caused by heat or moisture. Examples of the cellulose acylate and the negative-photoelastic coefficient layer which can be used in the moisture- and heat-resistant protective film of the invention are same as those to be used in the polarizing plate of the invention, and the preferable scopes thereof are same as those to be used in the polarizing plate of the invention.

### EXAMPLES

The present invention will be explained to further detail, referring to Examples. Note that the materials, reagents, amounts and ratios of substances, operations and so forth explained in Examples below may appropriately be modified without departing from the spirit of the present invention. The scope of the present invention is, therefore, not limited to the specific examples described below.

The properties described below were measured as follows.

### (Re and Rth)

In this description, Re(λ) and Rth(λ) are retardation (nm) in plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments). The selectivity of the measurement wavelength λ nm may be conducted by a manual exchange of a wavelength-filter, a program conversion of a measurement wavelength value or the like.

When a film to be analyzed is expressed by a monoaxial or biaxial index ellipsoid, Rth(λ) of the film is calculated as follows.

Rth(λ) is calculated by KOBRA 21ADH or WR based on six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane); a value of hypothetical mean refractive index; and a value entered as a thickness value of the film. In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR. Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to the following formulae (A) and (B):

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ \begin{matrix}{sin}^{- 1} \\ ( \frac{sin ( - θ )}{nx} )\end{matrix} \}} & ( A ) \\ Rth = [ \frac{nx + ny}{2} - nz ] \times d & ( B )\end{matrix}$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below:

cellulose acylate (1.48), cycloolefin polymer (1.52), polycarbonate (1.59), polymethylmethacrylate (1.49) and polystyrene (1.59).

KOBRA 21ADH or WR calculates nx, ny and nz, upon enter of the hypothetical values of these mean refractive indices and the film thickness. On the basis of thus-calculated nx, ny and nz, Nz=(nx−nz)/(nx−ny) is further calculated.

### (Degree of Acetylation)

The degree of acetylation was determined according to a method of ASTM D-817-91.

### (Viscosity-Averaged Degree of Polymerization)

The viscosity-averaged degree of polymerization was determined according to a limiting viscosity method of Uda, et al, (Kazuo Uda and Hideo Saito, JOURNAL OF THE SOClETY OF FIBER SCIENCE AND TECHNOLOGY, JAPAN, Vol. 18, No. 1, pp. 105-120 (1962)).

### 1. Preparation of Cellulose Acylate Film

1-1 Preparation of Cellulose Acylate Film 1 for VA mode Liquid Crystal Display Device

Each of the following dopes for inner layer and outer layer was prepared.

### Formulation of Dope for Inner Layer:

| | | |
|---|---|---|
| Cellulose Acetate C-1 | 100 | parts by mass |
| (the degree of acetylation: 2.81, | | |
| the number-averaged | | |
| molecular weight: 88000) | | |
| Optical Developer A having the | 7.0 | parts by mass |
| following structure | | |
| Polymer P-2 shown below | 9.0 | parts by mass |
| Bluing Dye B having the | 0.000078 | parts by mass |
| following structure | | |
| Dichloro Methane | 423.9 | parts by mass |
| Methanol | 63.3 | parts by mass |

### Formulation of Dope for Outer Layer:

| | | |
|---|---|---|
| Cellulose Acetate C-1 | 100 | parts by mass |
| (the degree of acetylation: 2.81, | | |
| the number-averaged | | |
| molecular weight: 88000) | | |
| Optical Developer A having the | 7.0 | parts by mass |
| following structure | | |
| Polymer P-2 shown below | 9.0 | parts by mass |
| Bluing Dye B having the | 0.000078 | parts by mass |
| following structure | | |
| Silica particles having a mean | 0.14 | parts by mass |
| diameter of 16 nm | | |
| (“Aerosol R972” from Nippon | | |
| Aerosil Co., Ltd) | | |
| Dichloro Methane | 424.5 | parts by mass |
| Methanol | 63.4 | parts by mass |

### Optical Developer A:

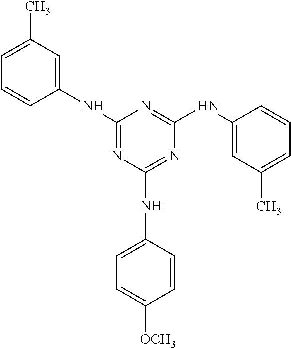

Polymer P-2: Polycondensation Polymer of a dicarboxylic acid residue of TPA/PA/SA/AA(=45/5/30/20 (% by mole)) and a diol residue of ethylene glycol (100% by mole), having the both ends terminated by an acetyl ester residue, and having the number-averaged molecular weight of 900.

### Bluing Dye B:

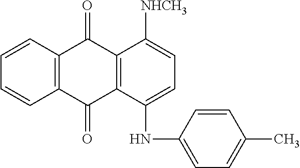

The dopes for outer layer and inner layer were subjected to uniform simultaneous lamination co-casting in a width of 2000 mm on a stainless band support using a band casting device, thereby obtaining a trilayer structure of an outer layer facing the support surface, an inner layer, and an outer layer facing the air intersurface. The solvent was evaporated by the stainless band support to such an extent that the residual solvent amount reached 40% by mass, and the film was peeled off from the stainless band support. Upon peeling, the film was stretched by applying a tension to a stretch ratio in the longitudinal direction (MD) of 1.02 times, and subsequently, both terminals were gripped by the tenter, and the film was stretched in the width direction (transverse stretching:TD) to a stretch ratio in the width direction (TD) of 1.22 times at a stretch rate of 45%/min. At the time of starting stretching, the residual solvent amount was 30% by mass. After stretching, the film was conveyed while being dried in a drying zone at 115 degrees Celsius for 35 minutes. After drying, the film was slit in a width of 1340 mm, thereby obtaining a cellulose acylate film having a thickness of 78 micro meters, and a film thickness ratio of the respective layers, the outer layer facing the support surface:the inner layer:the outer layer facing the air intersurface=3:94:3. This was used as Cellulose Acylate Film 1.

1-2 Preparation of Cellulose Acylate Film 2 for VA mode Liquid Crystal Display Device

Preparation of Particle Dispersion

A dispersion liquid of particles was prepared by mixing and stirring the following ingredients.

| | |
|---|---|
| Particles (“Aerosol R972V” from | 11 parts by mass |
| Nippon Aerosil Co., Ltd) | |
| Ethanol | 89 parts by mass |

Preparation of Particle Additive Liquid

A cellulose acylate was put into a dissolution tank with methylene chloride therein, in a ratio shown below, and completely dissolved under heat, then this was filtered through Azumi filter paper No. 244 (by Azumi Filter Paper). With fully stirring the filtered cellulose acylate solution, the fine particle dispersion prepared in the above was gradually added to it in a ratio shown below. Further, this was stirred with an attritor. This was filtered through Nippon Seisen's Finemet NF to give a particle additive liquid.

| | |
|---|---|
| Methylene chloride | 99 parts by mass |
| Cellulose Acylate (shown in the following table) | 4 parts by mass |
| Particle Dispersion | 11 parts by mass |

Preparation of Main Dope

A main dope having the following formulation was prepared. First, methylene chloride and ethanol were put into a pressure dissolution tank. Cellulose acylate was put into the pressure dissolution tank with the solvent therein, with stirring. This was heated and completely dissolved with stirring, and then a plasticizer and UV absorber shown in the following table were added to and dissolved therein. This was filtered through filter paper No. 244 (by Azumi Filter Paper) to give a main dope.

### <Formulation of Maind Dope>

| | |
|---|---|
| Methylene Chloride | 300 parts by mass |
| Ethanol | 60 parts by mass |
| Cellulose Acylate (shown in Table 1) | 73 parts by mass |
| Additive (shown in Table 1) | shown in Table 1 |

Preparation of Cellulose Acylate Film 2

100 parts by mass of the main dope and 2 parts by mass of the particle additive liquid were well mixed in an in-line mixer (Toray's static in-line mixer, Hi-Mixer, SVII) to prepare a dope. Using a belt casting machine, this was uniformly cast onto a stainless band support having a width of 2 m. On the stainless band support, the film was dried to have a residual solvent content of 110%, and then peeled away from the stainless band support. While peeled, this was stretched under tension in the machine direction (MD) at a 1.0-stretching ratio. Then, with both sides thereof held by a tenter, the web was further stretched in the transverse direction (TD) at a 1.3-stretching ratio whereupon the residual solvent content at the start of the stretching was 20% by mass and the temperature of the web was 130 degrees Celsius. After thus stretched, this was kept as such for a few seconds with its width kept as such whereby the tension in the transverse direction was relaxed, and thereafter this was released from being held in the transverse direction. Further, this was conveyed through a third drying zone set at 125 degrees Celsius for 30 minutes and was thus dried to give a cellulose acylate film having a width of 1.5 m as knurled on both edges thereof to a width of 1 cm and a height of 8 micro meters. This was used as Cellulose Acylate Film 2.

TABLE 1

| Cellulose | Cellulose Acylate | | Additive | | Stretching | |
|---|---|---|---|---|---|---|
| Acylate | Degree of Ac | Degree of Pr | | Amount | | Temperature |
| Film No. | substitution *1 | substituion *2 | Type *3 | [% by mass] | Ratio *4 | [° C.] |
| 2 | 1.6 | 0.9 | (a)/(b) | 1.7/6.3 | 1.30 | 130 |

*1: the degree of acetylation
*2: the degree of substitution with propionyl
*3: (a) is a commercial product of homo-oligomer of methyl acrylate (mean molecular weight 1000); (b) is Compound 3 described in paragraph [0058] in WO2007/125764; and (c) is a polycondensation-ester plasticizer of a mixed dicarboxylic acid (a mixed dicarboxylic acid of terephthalic acid/adipic acid/succinic acid in a molar ratio of 10/60/30) and a mixed diol (a mixed diol of ethylene glycol/1,2-propane diol in a molar ratio of 50/50), having the both ends terminated by an acetyl ester residue, and having the number-averaged molecular weight of 1000
*4: the strethcing ratio along the transverse direction perpendicular to the casting direction

1-3 Preparation of Cellulose Acylate Film 3 for VA mode Liquid Crystal Display Device

Each of the following dopes for inner layer and outer layer was prepared. Formulation of Dope for Inner Layer:

| | | |
|---|---|---|
| Cellulose Acetate (the degree of acetylation: 2.45) | 100 | parts by mass |
| Compound D*¹ | 19 | parts by mass |
| Methylene chloride | 365.5 | parts by mass |
| Methanol | 54.6 | parts by mass |

*¹Compound D is a copolymer of terephthalic acid/succinic acid/propylene glycol/ethylene glycol (cocopylmerization ratio (% by mole) = 27.5/22.5/25/25)

The concentration of the solid content of the dope for inner layer was 22% by mass and the viscosity of the dope for inner layer was 60 Pa·s.

### Formulation of Dope for Outer Layer:

| | | |
|---|---|---|
| Cellulose Acetate (the degree of acetylation: 2.79) | 100 | parts by mass |
| Compound D | 11 | parts by mass |
| Silica particles (“Aerosol R972” from Nippon | 0.15 | part by mass |
| Aerosil Co., Ltd) | | |
| Methylene chloride | 395.0 | parts by mass |
| Methanol | 59.0 | parts by mass |

The concentration of the solid content of the dope for inner layer was 19.7% by mass and the viscosity of the dope for inner layer was 40 Pa·s.

The dopes for inner and outer layers were cast respectively so that the dope for inner layer formed a core layer having a thickness of 56 micro meters and the dope for outer layer formed skin layers A and B having a thickness of 2 micro meters respectively. The web (film) was peeled off from the band, held by clips, and, subjected to a stretching treatment along the transverse direction at a 1.08-stretching ratio at a degree of 140 degrees Celsius by using a tenter at the time the amount of the residual solvent in the film was from 20 to 5% with respect to the total amount of the film. After that, the film was released from the clips, dried at 130 degrees Celsius for 20 minutes, and subjected to a stretching treatment along the transverse direction again at a 1.2-stretching ratio at a temperature of 180 degrees Celsius.

The residual solvent amount was computed according to the following formula:

Residual Solvent Amount (% by mass)={(M−N)/N}×100

In the formula, M is the mass of wet at an indefinite time, N is the mass of the web dried at 120 degrees Celsius for 2 hours after its M was measured

The cellulose acylate film prepared in this way was used as Cellulose Acylate Film 3.

1-4 Preparation of Cellulose Acylate Film 4 for IPS mode Liquid Crystal Display Device

The following ingredients were put into a tank, stirred under heat, and dissolved to give a cellulose acetate solution.

| | |
|---|---|
| Cellulose Acetate (the degree of acetylation: 2.86) | 100.0 parts by mass |
| Polyethylene Diol*¹ | 10 parts by mass |

*¹a polyester diol, having a hydroxy value of 113, formed of adipic acid and ethylene glycol

The solvent formulation was as follows.

| | | |
|---|---|---|
| Methylene chloride (First Solvent) | 100 | parts by mass |
| Methanol (Second Solvent) | 19 | parts by mass |
| 1-Butanol | 1 | part by mass |

The following ingredients were put into a disperser and dissolved under stirring to give a matting agent dispersion liquid. 1.3 parts by mass of the matting agent dispersion liquid was added to the cellulose acylate solution prepared above to give a dope, D-1.

### Formulation of Matting Agent Dispersion Liquid B-1

| | |
|---|---|
| Silica Particles Dispersion Liquid | 10.0 parts by mass |
| (the mean diameter of 16 nm; “Aerosol R972” from | |
| Nippon Aerosil Co., Ltd) | |
| Methylene Chloride | 72.8 parts by mass |
| Methanol | 3.9 parts by mass |
| Butanol | 0.5 parts by mass |
| Cellulose Acylate Solution*¹ | 10.3 parts by mass |

*¹the cellulose acylate solution prepared in the same manner as the cellulose acylate solution described above, except that 20 parts by mass of a polyester diol, having a hydroxy value of 156, formed of adipic acid and ethylene glycol was added to 100 parts by mass of the cellulose acetate (the substitution of 2.86)

The dope, D-1, was cast on a drum cooled by −5 degrees Celsius from the casting holes to form a film. The film was stripped off at a solvent content of 70% by mass and the film was fixed in both sides with a pin tenter (shown in FIG. 3 of JP-A No. 4-1009) and dried at a solvent content of from 3 to 5% by mass while maintaining intervals giving a stretching rate in the transverse direction (perpendicular to the machine direction) of 3%. Next, it was further dried by passing between rolls of a heat treatment unit to give a cellulose acetate film having a thickness of 60 micro meters. This was used as Cellulose Acylate Film 4.

1-5 Preparation of Cellulose Acylate Film 5 for IPS mode Liquid Crystal Display Device

The following ingredients were put into a tank, stirred under heat, and dissolved to give a cellulose acetate solution, A-5.

### Formulation of Cellulose Acylate Solution A-5

| | |
|---|---|
| Cellulose Acylate | 100 parts by mass |
| (the degree of acetylation: 2.86, the viscosity-averaged | |
| molecular weight: 310) | |
| Polycondensation Ester P-37 | 12 parts by mass |
| Methylene Chloride | 384 parts by mass |
| Methanol | 69 parts by mass |
| Butanol | 9 parts by mass |

Polycondensation ester P-37 is a polycondensation-ester plasticizer of a mixed dicarboxylic acid (a mixed dicarboxylic acid of terephthalic acid/adipic acid in a molar ratio of 50/50) and a mixed diol (a mixed diol of ethylene glycol/1,2-propane diol in amolar ratio of 50/50), having the both ends terminated by an acetyl ester residue, and having the number-averaged molecular weight of 1000 (Preparation of Matting Agent Dispersion Liquid B-5)

The following ingredients were put into a disperser and dissolved under stirring to give a matting agent dispersion liquid, B-5.

### Formulation of Matting Agent Dispersion Liquid B-5

| | |
|---|---|
| Silica Particles Dispersion Liquid | 10.0 parts by mass |
| (the mean diameter of 16 nm; “Aerosol R972” from | |
| Nippon Aerosil Co., Ltd) | |
| Methylene Chloride | 72.8 parts by mass |
| Methanol | 3.9 parts by mass |
| Butanol | 0.5 parts by mass |
| Cellulose Acylate Solution A-5 | 10.3 parts by mass |

### (Preparation of Uv-Absorber Solution C-5)

The following ingredients were put into a mixing-tank and dissolved under stirring and heat to give an UV-absorber solution, C-5.

### Formulation of UV-Absorber Solution C-5

| | | |
|---|---|---|
| UV-Absorber (UV-1 shown below) | 4.0 | parts by mass |
| UV-Absorber (UV-2 shown below) | 8.0 | parts by mass |
| UV-Absorber (UV-3 shown below) | 8.0 | parts by mass |
| Methylene Chloride | 55.7 | parts by mass |
| Methanol | 10 | parts by mass |
| Butanol | 1.3 | parts by mass |
| Cellulose Acylate Solution A-5 | 12.9 | parts by mass |

| | |
|---|---|
| 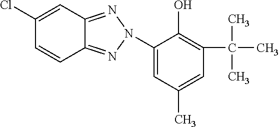 | (UV-1) |
| 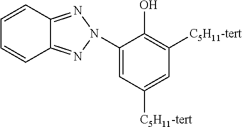 | (UV-2) |
| 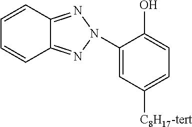 | (UV-3) |

### (Preparation of Cellulose Acylate Film 5)

The UV-absorber solution, C-5, was added to the mixture of 94.6 parts by mass of the cellulose acylate solution, A-5, and 1.3 parts by mass of the matting agent dispersion liquid, B-5, so that the amounts of UV absorbers, UV-2 and UV-3, were 0.4 part by mass, the amount of UV absorber, UV-1, was 0.2 part by mass, and the amount of the polycondensation ester, P-37, was 12 parts by mass with respect to 100 parts by mass of the cellulose acylate, under stirring and heat, and dissolved to give a dope. The dope was heated to 30 degrees Celsius, and then cast on a mirror surface of a stainless support, a drum having a diameter of 3 m, through a T-die. The surface temperature of the support was adjusted to −5 degrees Celsius, and the width in casting was adjusted to 1470 mm. The temperature in the whole atmosphere in the casting zone was adjusted to 15 degrees Celsius. The cellulose acylate film was peeled off from the drum at a 50 cm short from the terminal of the casting zone, and then, the both ends were clipped by a pin-tenter. Right after being peeled off, the amount of the residual solvent in the cellulose acylate web was 70% and the film-surface temperature was 5 degrees Celsius.

The cellulose acylate web held by the pin-tenter, was fed into a drying zone. First of the drying zone, dry air at 45 degrees Celsius was applied to the web. Next, the web was dried at 110 degrees Celsius for 5 minutes and then at 140 degrees Celsius for 10 minutes. Just before being reeled, the both end portions (5% of the total width each) of the film were cut off, and the film was knurled on both edges thereof to a width of 10 mm and a height of 50 micro meters. After that, the 3000 m-film was reeled into a roll form. In this way, a cellulose acylate film, having a width of 1.45 m, was prepared. This was used as Cellulose Acylate Film 5.

### 1-6 Preparation of Cellulose Acylate Film 6 for Comparative Example and for VA Mode Liquid Crystal Display Device

A cellulose acetate, having the substitution of acetylation of 2.81, plasticizer (a mixture of triphenyl phosphate (TPP) and biphenyl diphenyl phosphate (BDP); the ratio of TPP/BDP (to 100 parts by mass of the cellulose acetate)=7.8 parts by mass/3.9 parts by mass), an UV absorber (UV 1: 2(2′-hydroxy-3′,5′-di-tert-butylphenyl)benzotriazole), UV2: 2(2′-hydroxy-3′,5′-di-amylphenyl)-5-chlorbenzotriazole), and Retardation Enhancer (1) shown below (the ratio thereof with respect to 100 parts by mass of the cellulose acetate=6.4 parts by mass) were added to dichloromethane/methanol (87/13 parts by mass) under stirring so that the mass concentration of the cellulose acetate was 15% by mass), and dissolved under heat. At the same time, 0.05 part by mass of matting agent (AEROSIL R972 from Nippon Aerosil Co., Ltd) and 0.0009 part by mass of Dye (1) shown below were added to the mixture, and heated under stirring.

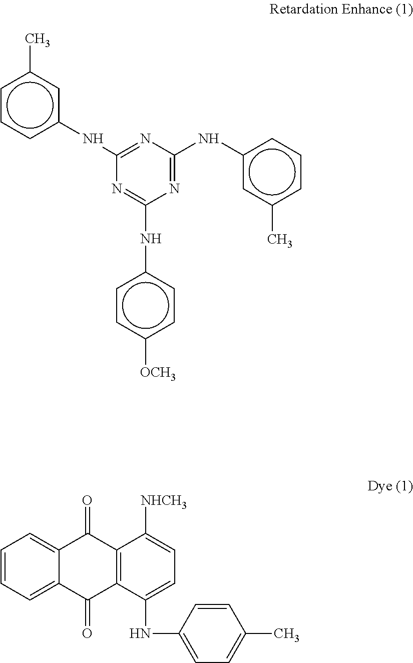

### (Casting)

The dope prepared above was cast by using a band-casting machine. The film was peeled off from the band when the content of the residual solvent in the film was from 25 to 35% by mass, subjected to a stretching treatment along the longitudinal direction at a 3%-stretching ratio in the area between the positions of peeling off and a tenter, subjected to a stretching treatment along the transverse direction at a 32%-stretching ratio by using the tenter, subjected to a shrinking treatment along the transverse direction at a 7%-ratio just after the stretching along the transverse direction, and released from the tenter. Just before being reeled, the both end portions of the film were cut off so the width of the film was 2000 mm, and then, the 4000 m-film was reeled into a roll form. In this way, a cellulose acylate film was prepared. This was used as Cellulose Acylate Film 6 for Comparative Example.

### 1-7 Preparation of Cellulose Acylate Film 7 for Comparative Example

A commercially available triacetyl cellulose film (“TD80” from FUJIFILM Corporation) was prepared. This was used as Cellulose Acylate Film 7.

### 2. Preparation of Negative-Photoelastic Coefficient Layer

### 2-1 Preparation of Negative-Photoelastic Coefficient Polymer Film N1

### Synthesis of Cyclic Clefinic Polymer P-1:

180 mass parts of purified toluene and 100 mass parts of norbornene-5-methanol acetate were put into a reaction vessel. Then, 0.04 part by mass of palladium (II) acetyl acetonate, 0.04 mass parts of tricyclohexyl phosphine, and 0.20 mass parts of dimethyl aluminum tetrakis (pentafluorophenyl)borate dissolved in 80 parts by mass of toluene were put into the reaction vessel. They were reacted under stirring at 90 degrees Celsiusfor 18 hours. After the completion of the reaction, the reaction mixture was put into an excess ethanol to form precipitates of polymerizates. A polymer (P-1) obtained by purifying the precipitates was dried in vacuum at 65 degrees Celsius for 24 hours.

The obtained polymer (P-1) was dissolved in tetrahydrofuran and, when the molecular weight was measured by gel permeation chromatography, the number average molecular weight was 79,000, and the mass average molecular weight was 205,000 being converted as polystyrene.

After charging the following composition in a mixing tank and dissolving each of the ingredients by stirring, they were filtered through filter paper with an average pore size of 34 micro meters and a sintered metal filter with an average pore size of 10 micro meters to obtain a cycloolefinic polymer solution.

### (Formulation of Cycloolefinic Polymer Solution)

| | |
|---|---|
| Cycloolefinic Polymer P-1 | 150 parts by mass |
| Dichloro Methane | 380 parts by mass |
| Methanol | 70 parts by mass |

The following ingredients containing the cycloolefinic polymer solution D-1 prepared by the method described above was charged in a dispersing device, to prepare a fine particle dispersion liquid M-1.

### (Formulation of Fine Particle Dispersion Liquid)

| | |
|---|---|
| Silica Particles Dispersion Liquid | 2 parts by mass |
| (the primary mean diameter of 16 nm; “Aerosol R972” | |
| from Nippon Aerosil Co., Ltd) | |
| Dichloro Methane | 73 parts by mass |
| Methanol | 10 parts by mass |
| Cycloolefinic Polymer Solution | 10 parts by mass |

100 mass parts of the cycloolefinic polymer solution and 1.43 mass of fine particle dispersion liquid were mixed to prepare a dope for film formation. The dope was cast by using a band casting device at a production speed of 20 m/min. A film peeled at a residual amount of the solvent of about 25% by masswas stretched along the transverse direction at a 2%-ratio by using a tenter, and dried by applying a hot blow while being held so as not to cause creases in the film.

Then, the tenter transportation was changed to the roll transportation, and the film was dried at 120 degrees Celsius to 140 degrees Celsius, and taken up to obtain a cycloolefinic polymer film. This was used as Polymer Film N1.

### 2-2 Preparation of Negative-Photoelastic Coefficient Polymer Film N2

An Acrylic polymer (“80N” from Asahi Kasei Chemicals Corporation) was prepared, and extruded by using an axtruder provided with a T-die from TECHNOVEL (“KZW15TW-25MG-NH” type; provided with a T-die having the width of 150 mm; the rip thickness of 0.5 mm) while the temperature of the polymer in the cylinder was adjusted to 247 degrees Celsius and the temperature of the T-die was adjusted to 250 degrees Celsius to form an unstretched film. This was used as Polymer Film N2.

### 2-3 Preparation of Negative-Photoelastic Coefficient Adhesive Layer N3

An ultraviolet cure acrylic adhesive, “UV-3400” (TOAGOSEI CO., LTD), was applied to a surface of a PEN film. Each of the cellulose acylate films was disposed on the surface of the layer, a 400 mJ/cm² of UV light was irradiated from the cellulose acylate film side so that the adhesive layer was hardened, and then the PEN film was removed. Any defect caused by peeling was not found in the film. The adhesive layer prepared in this way was used as Adhesive Layer N3.

The properties of the films or the like which were prepared according to the above-described methods were shown in the following tables. The photoelastic coefficient of Adhesive Layer N3 was measured as follows. An adhesive was applied to a surface of a sheet (e.g., silicone sheet, release sheet), showing little adhesion to the adhesive, to form an adhesive layer having a thickness of about 40 micro meters, the sheet was removed, and then the photoelastic coefficient of the layer alone was measured in the same manner as other films. The thickness of Adhesive Layer N3 shown in the following table is a thickness of Adhesive Layer N3 formed in each of the following examples.

TABLE 2

| | | | Averaged | | |
|---|---|---|---|---|---|
| | | Photoelastic | Elastic | | |
| | Thickness | coefficient | Modulus | Re | Rth |
| | (μm) | (×10⁻¹² Pa⁻¹) | (Mpa) | (nm) | (nm) |
| Cellulose Acylate | 76 | 16 | 4300 | 75 | 210 |
| Film 1 | | | | | |
| Cellulose Acylate | 43 | 17 | 3530 | 50 | 115 |
| Film 2 | | | | | |
| Cellulose Acylate | 59 | 13 | 4260 | 50 | 120 |
| Film 3 | | | | | |
| Cellulose Acylate | 60 | 11 | 3870 | 0 | 0 |
| Film 4 | | | | | |
| Cellulose Acylate | 40 | 14 | 4900 | 0 | 30 |
| Film 5 | | | | | |
| Cellulose Acylate | 82 | 17 | 4000 | 55 | 200 |
| Film 6 | | | | | |
| Cellulose Acylate | 80 | 14 | 3700 | 0 | 45 |
| Film 7 | | | | | |

TABLE 3

| | | Photoelastic |
|---|---|---|
| | Thickness | coefficient |
| | (μm) | (×10⁻¹² Pa⁻¹) |
| Polymer Film N1 | 40 | −5 |
| Polymer Film N2 | 40 | −3 |
| Adhesive Layer N3 | *1 | −3 |

*¹the thickness of Adhesive Layer N3 was varied depending on the examples, and was 10, 0.5 or 20 micro meters.

Each of Cellulose Acylate Films 1-7 was subjected to an alkali-saponification described below, and then was used for preparing a polarizing plate. Alkali-Saponification Treatment:

Each of the films was immersed in 1.5 mol/L-aqueous sodium hydroxide, saponifying liquid, of which temperature was controlled at 55 degrees Celsius, for two minutes, washed with water, and immersed in 0.05 mol/L-sulfuric acid aqueous solution for 30 seconds. After that, the film was allowed to go through flowing water for 30 seconds so that the film was neutralized. Then, after water was drained off therefrom with an air-knife three times, each film was passed into a drying zone at 70 degrees Celsius, and left there for 15 seconds. In this way, each of the cellulose acylate films was subjected to a saponification.

### 2. Preparation of Polarizing Plate

### 2-1 Preparation of Polarizing Plates 1N1-1N4

### Preparation of Polarizing Film:

According to the method of Example 1 described in JP-A 2001-141926A, polyvinyl alcohol film was stretched, and iodine was absorbed to the film. In this way a polarizing film having a thickness of 20 micro meters was prepared.

### Preparation of Polarizing Plate 1N1:

Using polyvinyl alcohol adhesive, Cellulose Acylate Film 1 was bonded to one surface of the polarizing film and Cellulose Acylate Film 7 was bonded to another surface of the polarizing film; and the lamination was dried at 70 degrees Celsius for 10 minutes or longer. In this way, Lamination 1 was prepared. Using a pressure-sensitive adhesive (“SK2057” from Soken Chemical & Engineering Co., Ltd.), Polymer Film N1 was bonded to the surface of Cellulose Acylate Film 1 in Lamination 1. In this way, Polarizing Plate 1N1 was prepared.

### Preparation of Polarizing Plate 1N2:

Lamination 1 was prepared according to a same method as described above. Using a pressure-sensitive adhesive (“SK2057” from Soken Chemical & Engineering Co., Ltd.), Polymer Film N2 was bonded to the surface of Cellulose Acylate Film 1 in Lamination 1. In this way, Polarizing Plate 1N2 was prepared.

### Preparation of Polarizing Plate 1N3:

Using an adhesive for Adhesive Layer N3, Cellulose Acylate Film 1 was bonded to one surface of the polarizing film; using a polyvinyl alcohol adhesive, Cellulose Acylate Film 7 was bonded to another surface of the polarizing film; and the lamination was dried at 70 degrees Celsius for 10 minutes or longer. In this way, Polarizing Plate 1N3 was prepared. The thickness of Adhesive Layer N3 was 10 micro meters.

### Preparation of Polarizing Plate 1N4:

Using a polyvinyl alcohol adhesive, Cellulose Acylate Film 1 was bonded to one surface of the polarizing film and Cellulose Acylate Film 7 was bonded to another surface of the polarizing film; and the lamination was dried at 70 degrees Celsius for longer than 10 minutes. In this way, Polarizing Plate 1N4 was prepared.

### 2-2 Preparation of Polarizing Plates 2N1-2N4

Polarizing Plates 2N1-2N4 were prepared respectively in the same manner of Polarizing plates 1N1-1N4, except that Cellulose Acylate Film 1 was replaced with Cellulose Acylate Film 2.

### 2-3 Preparation of Polarizing Plates 3N1-3N4

Polarizing Plates 3N1-3N4 were prepared respectively in the same manner of Polarizing plates 1N1-1N4, except that Cellulose Acylate Film 1 was replaced with Cellulose Acylate Film 3.

In preparation of Polarizing Plate 3N3, the thickness of Adhesive Layer N3 was 10 micro meters. In the same manner as Polarizing Plate 3N3, Polarizing plate 3N3(0.5), in which the thickness of Adhesive Layer N3 was 0.5 micro meter, was prepared. In the same manner as Polarizing Plate 3N3, Polarizing plate 3N3(30), in which the thickness of Adhesive Layer N3 was 30 micro meters, was also prepared.

### 2-4 Preparation of Polarizing Plates 4N1-4N4

Polarizing Plates 4N1-4N4 were prepared respectively in the same manner of Polarizing plates 1N1-1N4, except that Cellulose Acylate Film 1 was replaced with Cellulose Acylate Film 4.

### 2-5 Preparation of Polarizing Plates 5N1-5N4

Polarizing Plates 5N1-5N4 were prepared respectively in the same manner of Polarizing plates 1N1-1N4, except that Cellulose Acylate Film 1 was replaced with Cellulose Acylate Film 5.

### 2-6 Preparation of Polarizing Plates 6N1-6N4

Polarizing Plates 6N1-6N4 were prepared respectively in the same manner of Polarizing plates 1N1-1N4, except that Cellulose Acylate Film 1 was replaced with Cellulose Acylate Film 6.

### 2-7 Preparation of Polarizing Plates 7N1-7N4

Polarizing Plates 7N1-7N4 were prepared respectively in the same manner of Polarizing plates 1N1-1N4, except that Cellulose Acylate Film 1 was replaced with Cellulose Acylate Film 7.

2-8 Preparation of polarizing plate 0

Using a polyvinyl alsohol adhesive, Cellulose Acylate Film 7 was bonded to both surfaces of the polarizing film, and the lamination was dried at 70 degrees Celsius for 10 minutes or longer. In this way, Polarizing Plate 0 was prepared.

### 3. Preparation and Evaluation of Liquid Crystal Display Device

### 3-1 Preparation and Evaluation of VA-Mode Liquid Crystal Display Device (Having One Polarizing Plate of the Invention)

### Preparation of Va-Mode Liquid Crystal Cell:

A liquid crystal cell was prepared by regulating a cell gap between substrates at 3.6 micro meters and pouring dropwise a liquid crystal material with negative dielectric anisotropy (“MLC6608”, manufactured by Merck), followed by sealing to form a liquid crystal layer between the substrates. Retardation of the liquid crystal layer (namely, the product And of a thickness d (micro meter) of the liquid crystal layer and a refractive index anisotropy (Δn)) was regulated at 300 nm. The liquid crystal material was aligned so as to be vertically aligned.

### Bonding Liquid Crystal Cell and Polarizing Plate:

For preparing the liquid crystal display device employing the VA-mode liquid crystal cell described above, Polarizing Plate 0 was diposed as an upper polarizing plate of the liquid crystal display device, and any one of Polarizing Plates 1N1-1N4 and Polarizing Plates 6N1-6N4 was disposed as a lower polarizing plate of the liquid crystal display device. Polarizing Plates 1N1-1N4 or Polarizing Plates 6N1-6N4 were disposed respectively so that Cellulose Acylate Film 1 or Cellulose Acylate Film 6 was disposed on the liquid crystal cell side. The upper and lower polarizing plates were bonded to the liquid crystal cell respectively via a pressure-sensitive adhesive (“SK2057” from Soken Chemical & Engineering Co., Ltd.). The upper and lower polarizing plates were disposed in a crossed nicol alignment so that the transmission axis of the upper polarizing plate was along the vertical direction and the transmission axis of the lower polarizing plate was along the horizontal direction. In this way, VA-mode liquid crystal display devices 1N1-1N4 and liquid crystal display devices 6N1-6N4 were prepared.

### Evaluation:

Square wave current of 55 Hz was applied to the liquid crystal cell of each of the liquid crystal display devices. Each of the liquid crystal display devices employed a normally-black mode having the white state with 5V and the black state with 0 V.

Each of the liquid crystal display devices was left in the atmosphere of 50 degrees Celsius and 95% RH for 24 hours, and then it was allowed to operate for 24 hours. After that, any light leakage elliptically occurring at the center portion of the displaying plane in the black state was observed in the normal direction (in the direction normal to the displaying plane), and was evaluated in accordance with the following criterion. The results were shown in the following table.

9: The degree of light leakage was very small, which was enough for practical use. The visual quality was good.
8: The degree of light leakage was small, which was enough for practical use.
7: The degree of light leakage was small, which was enough for practical use. However, the degree of light leakage was worse than that of the level 8.
6: The degree of light leakage was small, which was enough for practical use. However, the degree of light leakage was worse than that of the level 7.
5: The degree of light leakage was small, which was enough for practical use. However, the degree of light leakage was worse than that of the level 6.
4: The degree of light leakage was small, which was enough for practical use. However, the degree of light leakage was the allowable limit.
3: The degree of light leakage was large, which was not enough for practical use.
2: The degree of light leakage was large, which was not enough for practical use. Furthermore, the degree of the light leakage was worse than the level 3.
1: The degree of light leakage was large, which was notenough for practical use. Furthermore, the degree of the light leakage was worse than the level 2.

TABLE 4

| | Cellulose | Negative- | | |
|---|---|---|---|---|
| Display | Acylate Film | photoelastic | | |
| Device | (thickness: μm) | Layer | Evaluation | Note |
| 1N1 | Cellulose Acylate | N1 | 5 | Example of |
| | Film 1 (76 μm) | | | Invention |
| 1N2 | Cellulose Acylate | N2 | 4 | Example of |
| | Film 1 (76 μm) | | | Invention |
| 1N3 | Cellulose Acylate | N3 | 6 | Example of |
| | Film 1 (76 μm) | | | Invention |
| 1N4 | Cellulose Acylate | — | 2 | Comparative |
| | Film 1 (76 μm) | | | Example |
| 6N1 | Cellulose Acylate | N1 | 2 | Comparative |
| | Film 6 (82 μm) | | | Example |
| 6N2 | Cellulose Acylate | N2 | 2 | Comparative |
| | Film 6 (82 μm) | | | Example |
| 6N3 | Cellulose Acylate | N3 | 2 | Comparative |
| | Film 6 (82 μm) | | | Example |
| 6N4 | Cellulose Acylate | — | 2 | Comparative |
| | Film 6 (82 μm) | | | Example |

From the results shown in the above-table, it is understandable that light leakage of each of the VA-mode liquid crystal display devices 1N1-1N3 was reduced remarkably, compared with that of the VA-mode liquid crystal display device 1N4. This is because Polarizing Plates 1N1-1N3, disposed in the VA-mode liquid crystal display devices 1N1-1N3, had a negative-photoelastic coefficient layer (Polymer Film N1, Polymer Film N2 or Adhesive Layer N3) along with Cellulose Acylate Film 1 having a thickness of 76 micro meters, and on the other hand, Polarizing Plate 1N4, disposed in the VA-mode liquid crystal display device 1N4, had no negative-photoelastic coefficient layer.

On the other hand, it is understandable that light leakage of each of the VA-mode liquid crystaldisplay devices 6N1-6N3, having Polarizing Plates 6N1-6N3 respectively containing Cellulose Acylate Film 6 with a thickness of 82 micro meters, even though Polarizing Plates 6N1-6N3 had a negative-photoelastic coefficient layer (Polymer Film N1, Polymer Film N2 or Adhesive Layer N3) along with the cellulose acylate film, was not reduced, which was not enough for practical use,

### 3-2 Preparation and Evaluation of VA-Mode Liquid Crystal Display Device (Having Two Polarizing Plates of the Invention)

For preparing the liquid crystal display device employing the VA-mode liquid crystal cell described above, any one of Polarizing Plates 2N1-2N4 and Polarizing Plates 3N1-3N4 was disposed as an upper polarizing plate of the liquid crystal display device, and the same was disposed as a lower polarizing plate of the liquid crystal display device. Polarizing Plates 2N1-2N4 or Polarizing Plates 3N1-3N4 were disposed respectively so that Cellulose Acylate Film 2 or Cellulose Acylate Film 3 was disposed on the liquid crystal cell side. The upper and lower polarizing plates were bonded to the liquid crystal cell respectively via a pressure-sensitive adhesive (“SK2057” from Soken Chemical & Engineering Co., Ltd.). Besided these, Liquid Crystal Display Devices 2N1-2N4 and Liquid Crystal Display Devices 3N1-3N4 were prepared in the same manner as VA-mode liquid crystal display devices 1N1-1N4. VA-mode liquid crystal display devices 3N3(0.5) and 3N3(30), having Polarizing Plate 3N3(0.5) containing Adhesive Layer N3 with a thickness of 0.5 micro meter and Polarizing Plate 3N3(30) containing Adhesive Layer N3 with a thickness of 30 micro meters respectively, were prepared respectively in the same manner as the above.

Each of the liquid crystal display devices was left in the atmosphere of 50 degrees Celsius and 95% RH for 24 hours, and then it was allowed to run for 24 hours. After that, any light leakage elliptically occurring at the center portion of the displaying plane in the black state was observed in the normal direction (in the direction normal to the displaying plane), and was evaluated in accordance with the above-described criterion. The results were shown in the following table.

TABLE 5

| | Cellulose | Negative- | | |
|---|---|---|---|---|
| Display | Acylate Film | photoelastic | | |
| Device | (thickness: μm) | Layer | Evaluation | Note |
| 2N1 | Cellulose Acylate | N1 | 6 | Example of |
| | Film 2 (43 μm) | | | Invention |
| 2N2 | Cellulose Acylate | N2 | 5 | Example of |
| | Film 2 (43 μm) | | | Invention |
| 2N3 | Cellulose Acylate | N3 | 7 | Example of |
| | Film 2 (43 μm) | | | Invention |
| 2N4 | Cellulose Acylate | — | 2 | Comparative |
| | Film 2 (43 μm) | | | Example |
| 3N1 | Cellulose Acylate | N1 | 8 | Example of |
| | Film 3 (59 μm) | | | Invention |
| 3N2 | Cellulose Acylate | N2 | 7 | Example of |
| | Film 3 (59 μm) | | | Invention |
| 3N3 | Cellulose Acylate | N3 | 9 | Example of |
| | Film 3 (59 μm) | (10 μm*¹) | | Invention |
| 3N3 (0.5) | Cellulose Acylate | N3 | 7 | Example of |
| | Film 3 (59 μm) | (0.5 μm*¹) | | Invention |
| 3N3 (30) | Cellulose Acylate | N3 | 7 | Example of |
| | Film 3 (59 μm) | (30 μm*¹) | | Invention |
| 3N4 | Cellulose Acylate | — | 2 | Comparative |
| | Film 3 (59 μm) | | | Example |

*¹Each of the numerical values shown in parentheses was the thickness of Adhesive Layer N3

From the results shown in the above-table, it is understandable that light leakage of each of the VA-mode liquid crystal display devices 2N1-2N3 and 3N1-3N3 was reduced remarkably, compared with that of the VA-mode liquid crystal display device 2N4 or 3N4. This is because Polarizing Plates 2N1-2N3 or Polarizing Plates 3N1-3N3, disposed in the VA-mode liquid crystal display devices 2N1-2N3 or 3N1-3N3, had a negative-photoelastic coefficient layer (Polymer Film N1, Polymer Film N2 or Adhesive Layer N3) along with Cellulose Acylate Film 2 with a thickness of 43 micro meters or Cellulose Acylate Film 3 with a thickness of 59 micro meters, and on the other hand, Polarizing Plate 2N4 or 3N4, disposed in the VA-mode liquid crystal display device 2N4 or 3N4, had no negative-photoelastic coefficient layer.

### 3-3 Preparation and Evaluation of IPS-Mode Liquid Crystal Display Device Preparation of Ips-Mode Liquid Crystal Cell:

An IPS-mode liquid crystal cell was prepared by taking it from a commercially-available IPS-TV carefully.

### Bonding Liquid Crystal Cell and Polarizing Plate:

For preparing the liquid crystal display device employing the IPS-mode liquid crystal cell described above, any one of Polarizing Plates 4N1-4N4, Polarizing Plates 5N1-5N4 and Polarizing Plates 7N1-7N4 was disposed as an upper polarizing plate of the liquid crystal display device, and the same was disposed as a lower polarizing plate of the liquid crystal display device. Polarizing Plates 4N1-4N4, Polarizing Plates 5N1-5N4 or Polarizing Plates 7N1-7N4 were disposed respectively so that Cellulose Acylate Film 4, Cellulose Acylate Film 5 or Cellulose Acylate Film 7 was disposed on the liquid crystal cell side. The upper and lower polarizing plates were bonded to the liquid crystal cell respectively via a pressure-sensitive adhesive (“SK2057” from Soken Chemical & Engineering Co., Ltd.). The upper and lower polarizing plates were disposed in a crossed nicol alignment so that the transmission axis of the upper polarizing plate was along the vertical direction and the transmission axis of the lower polarizing plate was along the horizontal direction. In this way, IPS-mode liquid crystal display devices 4N1-4N4, 5N1-5N4 and 7N1-7N4 were prepared.

Each of the liquid crystal display devices was left in the atmosphere of 50 degrees Celsius and 95% RH for 24 hours, and then it was allowed to run for 24 hours. After that, any light leakage elliptically occurring at the center portion of the displaying plane in the black state was observed in the normal direction (in the direction normal to the displaying plane), and was evaluated in accordance with the above-described criterion. The results were shown in the following table.

TABLE 6

| | Cellulose | Negative- | | |
|---|---|---|---|---|
| Display | Acylate Film | photoelastic | | |
| Device | (thickness: μm) | Layer | Evaluation | Note |
| 4N1 | Cellulose Acylate | N1 | 6 | Example of |
| | Film 4 (60 μm) | | | Invention |
| 4N2 | Cellulose Acylate | N2 | 5 | Example of |
| | Film 4 (60 μm) | | | Invention |
| 4N3 | Cellulose Acylate | N3 | 7 | Example of |
| | Film 4 (60 μm) | | | Invention |
| 4N4 | Cellulose Acylate | — | 2 | Comparative |
| | Film 4 (60 μm) | | | Example |
| 5N1 | Cellulose Acylate | N1 | 8 | Example of |
| | Film 5 (40 μm) | | | Invention |
| 5N2 | Cellulose Acylate | N2 | 7 | Example of |
| | Film 5 (40 μm) | | | Invention |
| 5N3 | Cellulose Acylate | N3 | 9 | Example of |
| | Film 5 (40 μm) | | | Invention |
| 5N4 | Cellulose Acylate | — | 2 | Comparative |
| | Film 5 (40 μm) | | | Example |
| 7N1 | Cellulose Acylate | N1 | 2 | Comparative |
| | Film 7 (80 μm) | | | Example |
| 7N2 | Cellulose Acylate | N2 | 2 | Comparative |
| | Film 7 (80 μm) | | | Example |
| 7N3 | Cellulose Acylate | N3 | 2 | Comparative |
| | Film 7 (80 μm) | | | Example |
| 7N4 | Cellulose Acylate | — | 2 | Comparative |
| | Film 7 (80 μm) | | | Example |

From the results shown in the above-table, it is understandable that light leakage of each of the IPS-mode liquid crystal display devices 4N1-4N3 and 5N1-5N3 was reduced remarkably, compared with that of the IPS-mode liquid crystal display device 4N4 or 5N4. This is because Polarizing Plates 4N1-4N3 or Polarizing Plates 5N1-5N3, disposed in the IPS-mode liquid crystal display devices 4N1-4N3 or 5N1-5N3, had a negative-photoelastic coefficient layer (Polymer Film N1, Polymer Film N2 or Adhesive Layer N3) along with Cellulose Acylate Film 4 with a thickness of 60 micro meters or Cellulose Acylate Film 5 with a thickness of 40 micro meters, and on the other hand, Polarizing Plate 4N4 or 5N4, disposed in the IPS-mode liquid crystal display device 4N4 or 5N4, had no negative-photoelastic coefficient layer.

On the other hand, it is understandable that light leakage of each of the IPS-mode liquid crystal display devices 7N1-7N3, having Polarizing Plates 7N1-7N3 respectively containing Cellulose Acylate Film 7 with a thickness of 80 micro meters, even though Polarizing Plates 7N1-7N3 had a negative-photoelastic coefficient layer (Polymer Film N1, Polymer Film N2 or Adhesive Layer N3) along with the cellulose acylate film, was not reduced, which was not enough for practical use,

What is claimed is:

1. A polarizing plate comprising:
a polarizing film, and on one surface thereof,
a cellulose acylate film having a thickness of equal to or less than 77 micro meters, and
a layer having a negative photoelastic coefficient.

2. The polarizing plate of claim 1, wherein an averaged elastic modulus of the cellulose acylate film along a cross direction and a longitudinal direction is equal to or more than 3800 MPa.

3. The polarizing plate of claim 1, wherein the layer having a negative photoelastic coefficient is an adhesive layer bonding the cellulose acylate film and the polarizing film.

4. The polarizing plate of claim 3, wherein the adhesive layer is formed of a composition comprising an acrylic adhesive.

5. The polarizing plate of claim 4, wherein the thickness of the adhesive layer is from 1 to 20 micro meters.

6. The polarizing plate of claim 1, wherein the layer having a negative photoelastic coefficient is a polymer film comprising a cycloolefinic polymer or an acrylic polymer.

7. A liquid crystal display device comprising:
a polarizing plate of claim 1, and
a liquid crystal cell.

8. The liquid crystal display device of claim 7, wherein the polarizing plate is disposed at a backlight side.

9. The liquid crystal display device of claim 7, wherein a layer having a negative photoelastic coefficient and a cellulose acylate film in the polarizing plate are disposed between the liquid crystal cell and a polarizing film in the polarizing plate.

10. A moisture- and heat-resistant protective film to be used in a polarizing plate, comprising:
a cellulose acylate film having a thickness of equal to or less than 77 micro meters, and
a layer having a negative photoelastic coefficient.

11. The protective film of claim 10, wherein an averaged elastic modulus of the cellulose acylate film along a cross direction and a longitudinal direction is equal to or more than 3800 MPa.

12. The protective film of claim 10, wherein the layer having a negative photoelastic coefficient is a polymer film comprising a cycloolefinic polymer or an acrylic polymer.
